(19) United States
(12) Patent Application Publication
(10) Pub. No.: US 2010/0293463 A1
(43) Pub. Date: Nov. 18, 2010

(54) System for Creation and Playback of a Multi-media Enhanced Narrative

(76) Inventors: Mike K. Snyder, (US); Diana J. Snyder, (US)

Correspondence Address: Ties That Bind Us, Inc., 75 1/2 Corey Ave., Saint Pete Beach, FL, 33706, US

(21) Appl. No.: 12/765,086

(22) Filed: Apr. 22, 2010

Related U.S. Application Data
(60) Provisional application No. 61/216,135, filed on May 14, 2009.

(51) Int. Cl. G06F 3/01; G06F 15/16

(52) U.S. Cl. 715/716; 709/203; 715/760

(57) ABSTRACT

This invention is a system which may allow the creation, synchronization, and delivery of a digital video and digital audio recording in combination with books, articles, stories or other narrative in digital format such that they appear to be a synchronized and coordinated playback. It may allow users to create, and view said playback. A client-server system may be utilized for creation, storage, and delivery of said narrative, said recording, and software instructions for recording and playback. Said playback may be created when a narrative is selected from said server for integration with said recording. Said recording may be created in conjunction with said narrative while narrative actions with timestamp data may chosen. Said narrative actions may move said narrative forward, backward, and otherwise direct and control said playback. Said recording, said narrative action data, and said timestamp data may also be stored in a data repository via said server. Said client machine may have the ability to load said playback for the purpose of viewing said playback.

### PATENT TEST CASE

This non-provisional Patent Application claims priority to Provisional Patent Application No. 61/216,135 filed on May 14, 2009.

### REFERENCES CITED

US PATENT DOCUMENTS

| | | |
|---|---|---|
| 6,933,928 | August 2005 | Scott |
| 4,833,718 | May 1989 | Sprague |
| 6,421,524 | July 2002 | Padgett |
| 6,933,928 | August 2005 | Lilienthal |
| 6,985,913 | January 2006 | Murata |
| 7,516,073 | April 2009 | Kodama |
| 20080222156 | September 2008 | Ryan, Zehr, Marine |

FOREIGN PATENT DOCUMENTS

| | | |
|---|---|---|
| CN1412687 | April 2003 | CN |
| EP1449195 | December 2002 | CN |
| WO9424667 | October 1994 | WO |

### BACKGROUND OF THE INVENTION

This invention relates to the recording and subsequent playback of digital video and digital audio in combination with books, articles, stories, images or other narrative in digital format such that a synchronized and coordinated playback may be achieved. Creation and playback may utilize a client-server machine system. Furthermore said client machine may utilize video and audio recording capabilities.

Recording and playback of digital video and digital audio may be known. Likewise, delivery and display of digital narrative content may also be known. Furthermore it may be know how to generate audio from text in said narrative based on existing phoneme data or an individual user's phoneme data. However, these may not allow for the creation of said recording in conjunction with and said narrative as a synchronized and coordinated playback.

### SUMMARY OF THE INVENTION

This invention is a system which may allow the creation, synchronization, and delivery of a digital video and digital audio recording in combination with books, articles, stories or other narrative in digital format such that they appear to be a synchronized and coordinated playback. It may allow users to create, and view said playback. A client-server system may be utilized for creation, storage, and delivery of said narrative, said recording, and software instructions for recording and playback. Said playback may be created when a narrative is selected from said server for integration with said recording. Said recording may be created in conjunction with said narrative while narrative actions with timestamp data may chosen. Said narrative actions may move said narrative forward, backward, and otherwise direct and control said playback. Said recording, said narrative action data, and said timestamp data may also be stored in a data repository via said server. Said client machine may have the ability to load said playback for the purpose of viewing said playback.

These, and other facets and advantages of the invention, will become better understood with reference to the drawings, description, and claims which follow.

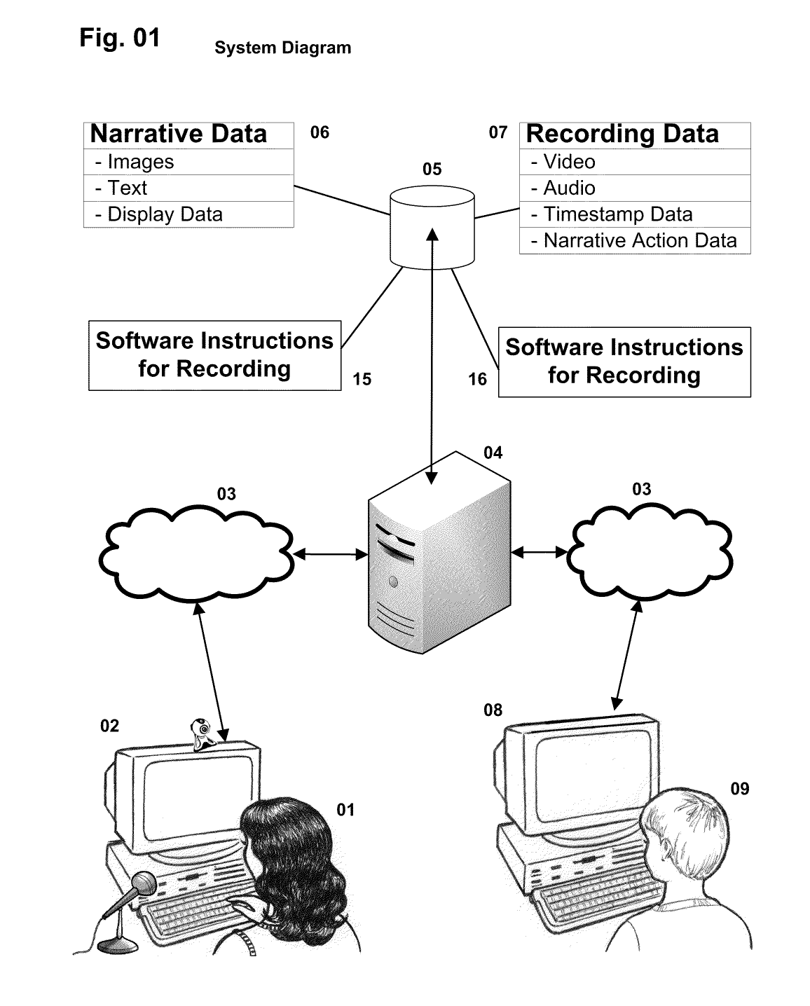

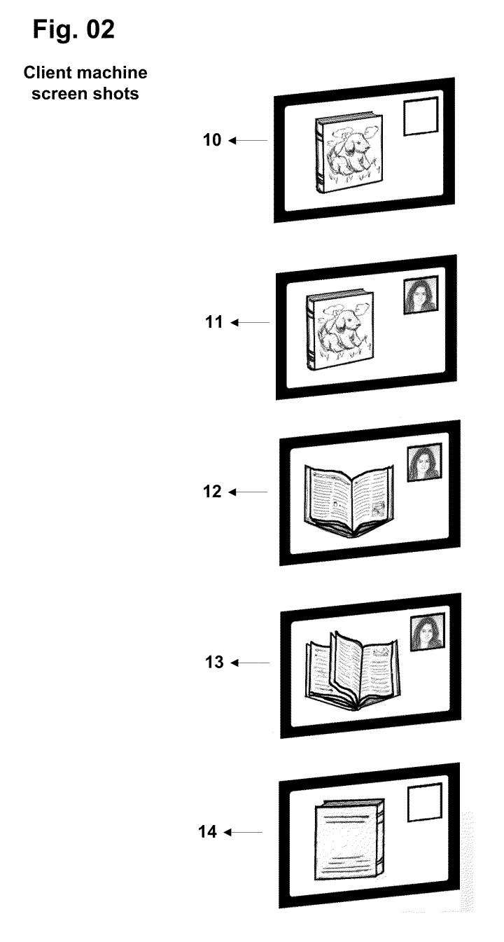

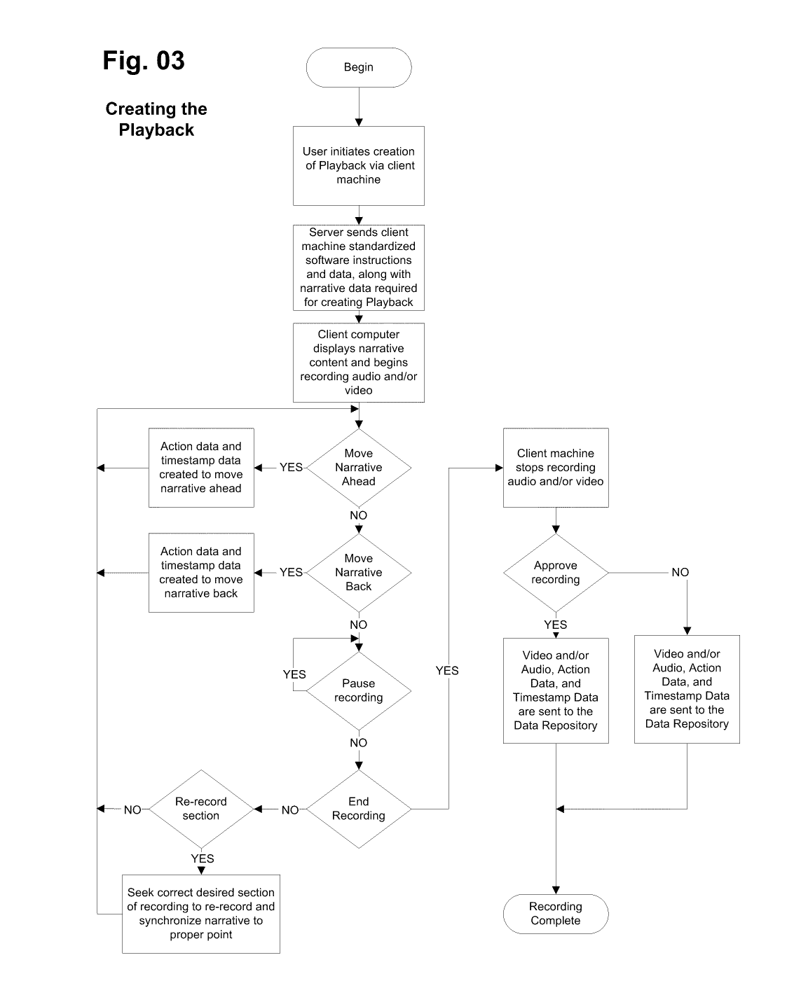

### DESCRIPTION OF DRAWINGS

[FIG. 01] System overview for creation and viewing of playback depicting: a user creating the playback 01, a client machine having tactile, visual, and auditory user interfaces with audio and video capture capabilities facilitated via hardware, operating system, and software capable of connecting to the server, reading and executing software instructions delivered by the server, reading and properly displaying narrative content 02, network connection from client to server 03, server with operating system, hardware and software capable of interacting with a data repository, accepting connections from other networked client machines, and storing, retrieving, and delivering narrative content, recordings, narrative action data, timestamp data, and software instructions for client machines 04, data repository 05, narrative data including images, text, and display data 06, recording data including video, audio, narrative action data, and timestamp data 07, a client machine similar to that of 02 excepting the requirement of audio and video capture capabilities 08, a user viewing playback 09, software instructions for recording 15, software instructions for playback 16

[FIG. 02] Client machine's screen depicting: 10 narrative displayed with no recording, 11, recording of audio and video has begun, 12 narrative action: book has been opened, 13 narrative action: page is turning, 14 narrative complete, recording stopped,

[FIG. 03] Flow chart of playback creation

### DETAILED DESCRIPTION OF THE INVENTION

The client machine in this patent may refer to any electronic device provided it has the user interface, networking interface and required capabilities to serve as a said client machine 02 for purposes of recording and playback, and said client machine 08 for purposes of playback only. Though FIG. 01 depicts 02 and 08 as desktop computers, a client machine may be but is not limited to being: a desktop computer, a workstation computer, a laptop computer, a tablet computer, a mobile computing device, and a mobile phone.

A variety of existing industry standard operating systems, software, and software development platforms and tools may be utilized for display of narrative data, creation of narrative actions, creation of timestamp data and storage of narrative data and recording data in the system proposed. These include but are not limited to Linux, Microsoft Server, ASP.NET, PHP, Adobe Flash, Microsoft Silverlight, and various languages capable of producing Active-X and other plug-in components.

The following description details a system which may allow the creation, synchronization, and delivery of a digital video and digital audio recording in combination with books, articles, stories or other narrative in digital format such that they appear to be a synchronized and coordinated playback.

Referring to FIG. 01, the system may require that said narrative data 06 is resident in a data repository 05 accessible by means of a server 04. Said narrative data may include images, text and any display data required to properly display said narrative in a manner consistent with the intent of said narrative's author. Said server may have an operating system, software, and hardware sufficient to send a client machine said narrative data via an internet or other networked connection to said server.

Said client machine 02 may be utilized to create and view the playback. Said client machine 02 may connect to and request from said server 04, software components and data, and said narrative data 06 such that said client machine 02 may display said narrative allowing a user 01 to view said narrative data 06 and begin creating said recording, utilizing said client machine 02 video and audio recording capabilities. As said user 01 is creating said recording, said user 01 may effect, via user interface on said client machine 02, a narrative action to move said narrative forward or backwards for the purpose of synchronizing said recording audio and video of said user 01 to said narrative. As said narrative actions are created, said narrative may respond by turning said narrative's page to advance or go back in said narrative. Said action data may be accompanied by said timestamp data to indicate correct timing of said narrative action upon playback. In addition, other audio and or graphical effects may be added upon selection and usage of said narrative actions. Said user 01 may complete and approve said recording so that said client machine 02 may transmit said recording data 07 to said server 04 for persisting in said data repository 05.

While in the process of creating said recording, said user 01 may pause and resume said recording at will.

While in the process of creating said recording, said user 01 may re-record a segment between said timestamp data. User 01 may create a playback containing a plurality of narrative actions and thus, segments. In the case where five narrative actions and timestamp data were created, there would be six total segments. Said user 01 may have the ability to re-record any of those six segments.

While in the process of creating said recording, said user 01 may terminate said recording without persisting said recording data 07.

Subsequent to user 01 creating said playback and persisting via server 04, user 09 may utilize said client machine 08 to retrieve said playback from said server 04 containing all narrative data and recording data required for the purpose viewing said playback. As said playback is displaying, said narrative is displayed and may be advanced or moved back as said narrative actions dictate when said timestamp data are reached.

What is claimed is the following:

01. A system facilitating creation and playback of a narrative enhanced with a user's audio and/or video recording allowing said user to set narrative actions as said playback is created in order to effect said narrative's playback behavior comprising:
said system having a server capable of facilitating and coordinating the creation of said recording in conjunction with said narrative to create said playback;
said system having a plurality of client machines having the hardware and software capabilities to facilitate user interaction with said system;
said plurality of client machines having the hardware and software capabilities to facilitate creation of said recording in conjunction with said narrative to create said playback as defined by software instructions for recording and software instructions for playback;
said server having access to a data repository for the purpose of storage and access of said narrative's data, said software instructions for playback, said software instructions for recording, and said recording's data;
said software instructions for recording further having instructions for creation of narrative actions as desired by said user;
said server and said plurality of client machines having internet networking connectivity between each other;
said narrative being an existing narrative stored in said data repository with images, text and data required to properly display said narrative in a manner consistent with the intent of said narrative's author.

02. The system as in claim 01 wherein said server may have the hardware and software sufficient to act in the capacity of a web-server for said plurality of client machines.

03. The system as in claim 01 wherein said client machines may have the hardware and software sufficient to interact with said server via client machine's web browser.

04. The system as in claim 01 wherein said narrative may be requested in conjunction with said software instructions for playback by said plurality of client machines for the purpose of displaying said playback.

05. The software instructions for playback as in claim 04 wherein said playback may be advanced, moved backward and otherwise directed by narrative actions created at the time said user created said recording in conjunction with said narrative and having timestamp data generated as a means for coordinating said playback.

06. The system as in claim 01 wherein said narrative may be requested in conjunction with said software instructions for recording and said software instructions for playback by said plurality of client machines for the purpose of creating said playback.

07. The instructions as in claim 06 wherein said narrative may be advanced, moved backward and otherwise directed by said narrative actions as desired by said user during creation of said recording in conjunction with said narrative and having said timestamp data generated as a means for coordinating said playback when said narrative actions are selected.

08. The narrative actions as in claim 07 may be accompanies by additional sound, and/or graphical effects.

09. The recording as in claim 07 may be paused, resumed, stopped, and restarted as desired by said user.

10. The playback as in claim 07 may be approved by said user to store in said data repository via said server at the completion of creation of said recording.

11. The recording as in claim 07 may have a recording segment between said narrative actions re-recorded before approval by said user to store said recording as part of said playback on said data repository.

12. The recording as in claim 07 may not require a continuous connection to said server during creation of said recording as long as required data and instructions have been received by said plurality of client machines to facilitate completion of recording said playback.

13. The playback as in claim 01 comprised of said narrative and said recording may further be combined in a manor to create a completed digital movie in digital movie formats which may be stored in whole on electronic storage devices and mediums as well as transmitted electronically for viewing utilizing a variety of generally available digital movie players.
